(19) United States
(12) Patent Application Publication
(10) Pub. No.: US 2025/0047788 A1
(43) Pub. Date: Feb. 6, 2025

(54) SYSTEMS AND METHODS FOR AUTOMATIC EMERGENCY CALL MANAGEMENT

(71) Applicant: HelpE Ltd., Kfar Maas (IL)

(72) Inventors: OREN BLUSTEIN, KFAR MAAS (IL); ETAN HAYIK, YAVNE (IL); IDO ROSENBLAT, PETACH TIKVA (IL)

(21) Appl. No.: 18/792,606

(22) Filed: Aug. 2, 2024

Related U.S. Application Data
(60) Provisional application No. 63/530,259, filed on Aug. 2, 2023.

(51) Int. Cl. H04M 3/51; H04M 3/22; H04M 3/42; H04M 3/523

(52) U.S. Cl. CPC H04M 3/5116; H04M 3/2281; H04M 3/42059; H04M 3/42348; H04M 3/5235; H04M 2203/2061

(57) ABSTRACT

Systems and methods for managing service calls using automatic agents to process incoming calls to streamline the performance of telephonic service providers. Automatic call management systems screen inbound calls to use call identification markers to identify high priority calls and to deprioritize nuisance calls. Emergency response units may be dispatched as soon as sufficient information has been obtained even before the call has been fully processed with additional details being communicated to the emergency unit in transit. Retrofittable automatic caller interfaces may be added onto existing telephonic service providers.

### CROSS-REFERENCE TO RELATED APPLICATIONS

This application claims the benefit of priority from U.S. Provisional Patent Application No. 63/530,259, filed Aug. 2, 2023, which is incorporated herein by reference in their entirety.

### FIELD

The invention relates generally to systems and methods for managing incoming service calls. In particular, the invention relates to systems and methods for automatically receiving and processing emergency calls.

### BACKGROUND

Emergency call and response services are vital component for a modern society and are heavily used. About 240 million 911 calls are made each year in The United States and about 267 million 112 calls are made each year in Europe.

Emergency call and response services do more than just provide lifesaving assistance in real time where it is needed by dispatching emergency services, such as firefighters, ambulance services, police, coastguards and the like. Even when the service is not required, the knowledge that help is available at the end of a phone line provides constant reassurance to the entire population as they go about their business.

By their nature, emergency services need to be provided as quickly as possible, it is therefore necessary that Emergency calls are processed quickly. In the United States, the National Fire Protection Association (NFPA) released the NFPA 1225 Standard for Emergency Services Communications in 2022 as part of The Emergency Response and Responder Safety Document Consolidation Plan which outlines the time standards for processing emergency calls. According to the NFPA 1225 standards, 90% of inbound calls should be answered within 15 seconds and 95% within 20 seconds. Moreover, according to the standards, 90% of high priority calls should be processed fast enough to dispatch an Emergency Response Unit within 60 seconds of the call being answered.

Emergency calls are generally handled by public safety answering points (PSAPs) which, in practice, struggle to meet the demands made upon them. According to a 2022 NFPA Analysis of Public Safety Call Answering and Processing Times fewer than 75% of calls are answered within the standard 15 seconds, and fewer than 50% are processed within 60 seconds. These figures are even worse during known transient call volume increase due to predictable events, such as sporting events, concerts, rush-hour, tourist season and the like.

There are many factors which impact PSAP reply and response times, in particular staffing limitations can create bottle necks when many calls are incoming simultaneously.

Thus, the need remains therefore, for an automated system for answering and processing incoming emergency calls. The invention described hereinbelow addresses the above-described needs.

### SUMMARY

According to one aspect of the invention, a method is provided including receiving at least one incoming telephone call, screening the at least one incoming call, if the incoming call is from a valid caller then executing a valid call protocol. The valid call protocol may comprise connecting the valid caller to a service agent, prompting the valid caller for information pertaining to the service required, receiving the information pertaining to the service required, processing information pertaining to the service required, determining a required action, and executing the required action.

The step of screening may comprise obtaining call identification markers from the callers such as caller phone numbers, caller locations, advance mobile locations (AML) and the like. Optionally, the step of screening comprises assigning a prioritization index to a valid caller.

Where appropriate, the step of screening comprises executing a non-valid call protocol if the incoming call is from a non-valid caller. For example, the non-valid call protocol may comprise rejecting the non-valid call, reporting the non-valid caller to authorities or alerting law enforcement.

Variously, executing the required action may comprise providing service information to the caller, establishing a parallel remote connection to a caller device, performing banking transactions, dispatching an emergency response unit, determining if an emergency dispatch is required, connecting the caller to a human service agent or the like as well as combinations thereof.

Where appropriate the method may further include establishing a preferred language for communicating with the caller. Accordingly, the step of prompting the valid caller for information pertaining to the service required may include asking prompting questions in the preferred language for communicating with the caller.

Optionally the method includes categorizing the incoming call according to the information prompted from the caller for example by assigning a category selected from emergency call, non-emergency call, harassment call, nuisance call, service request call, information call, extension call, routing call, common call, repeat call and the like as well as combinations thereof.

According to another aspect of the invention, a method is provided for automatic emergency call management, the method including receiving an incoming call from a caller, obtaining incoming call identification markers, applying a call filter, assigning a prioritization value to the incoming call, routing call according to prioritization value, connecting automatic service agent to caller, automatic agent prompting caller for information, categorizing call according to the information prompted from the caller, and establishing that a dispatch is required, checking if an emergency response unit has already been dispatched, and if no emergency response unit has already been dispatched then dispatching unit to emergency.

According to another aspect of the invention, an automatic service-call management system is provided, the system including an inbound call screener configured and operable to receive inbound call identifiers, to identify nuisance calls, and to block identified nuisance calls, an automatic call distributer configured and operable to prioritize inbound calls, a call router configured to connect a caller to at least one automatic customer service agent, at least one automatic customer service agent configured to prompt the caller for key information and to store the key information in a memory, and a call processor configured to determine a required course of action for the incoming call. Accordingly, the system may further include an emergency unit dispatch router configured and operable to communicate with dispatch units.

### BRIEF DESCRIPTION OF THE DRAWINGS

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments of the invention only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the various selected embodiments of the invention may be put into practice. In the accompanying drawings:

FIG. 1 is a block diagram representing selected elements of a system for managing incoming service calls;

FIG. 2 is a schematic diagram representing elements of an automatic emergency call management system;

FIG. 3 is a flowchart illustrating selected actions of a method for processing an emergency call using the automatic emergency call management system; and

FIGS. 4A-M are illustrative screen shots representing multiple emergency calls being handled by multiple automatic agents in parallel during a typical minute of operation of the emergency system.

### DETAILED DESCRIPTION

Aspects of the invention relate to systems and methods for managing service calls. In particular, the invention relates to systems and methods for using automatic agents to process incoming calls and for streamlining the performance of public-safety answering points (PSAPs).

An automatic call management system is introduced herein which provides capacity to process multiple inbound calls in parallel. The system may screen the inbound calls so that unnecessary calls are deprioritized and may further use call identification markers such as phone numbers and caller locations to identify high priority calls which may be processed quicker.

A dispatch manager may be provided to dispatch emergency response units as soon as sufficient information has been obtained to determine that this is necessary. Notably, where required, the dispatch manager may dispatch the emergency response units even before the call has been fully processed with additional details being communicated to the emergency unit in transit.

In other embodiments of the invention, retrofittable automatic caller interfaces may be provided which when added onto existing telephonic service providers extend their functionality accordingly.

In various embodiments of the invention, one or more tasks as described herein may be performed by a data processor, such as a computing platform or distributed computing system for executing a plurality of instructions. Optionally, the data processor includes or accesses a volatile memory for storing instructions, data or the like. Additionally, or alternatively, the data processor may access a non-volatile storage, for example, a magnetic hard-disk, flash-drive, removable media or the like, for storing instructions and/or data.

It is particularly noted that the systems and methods described herein are not limited in their application to the details of construction and the arrangement of the components or methods set forth in the description or illustrated in the drawings and examples. The invention includes other embodiments and may be practiced and carried out in various ways and using various technologies.

Alternative methods and materials similar or equivalent to those described herein may be used in the practice or testing of embodiments of the invention. Nevertheless, particular methods and materials are described herein for illustrative purposes only. The materials, methods, and examples are not intended to be necessarily limiting.

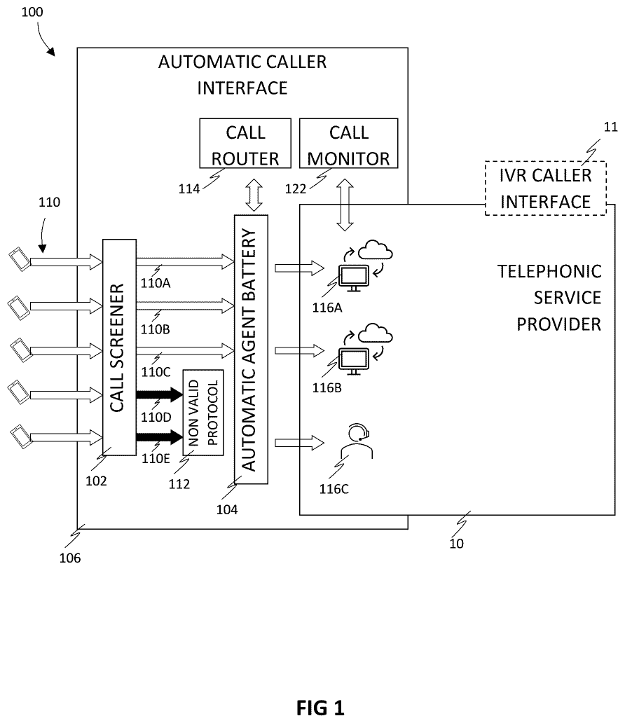

Reference is now made to the block diagram of FIG. 1 which schematically represents a service call management system 100 according to embodiments of the invention. The system may include an automatic caller interface 106 which may be retrofitted to a telephonic service provider 10 to streamline the management of incoming calls. The telephonic service provider 10 may be a pre-existing service system providing functionality such as customer service, telephonic banking and the like. Such telephonic service providers 10 generally interface with callers via interactive voice response (IVR) interfaces 11, voice response units (VRU0 and the like which typically demand that the caller listens to multiple menus and selects options either verbally or by pressing particular keys.

The service call management system 100 described herein provides an automatic caller interface 106 including a call screener 102, a automatic agent battery 104, a call router 114 and a call monitor 122.

Multiple inbound emergency calls 110 from multiple callers are screened by the call screener 102, which is configured and operable to obtain call identification markers, such as caller phone numbers, caller locations, advance mobile locations (AML) and the like. Accordingly, the call screener may filter valid calls 110A, 110B, 110C from invalid calls 110D, 110E, such as nuisance calls or cyber attacks. Where required, a non-valid call protocol may be initiated for example rejecting or reporting the non-valid call and where necessary alerting law enforcement authorities.

Valid calls 110A, 110B, 110C are typically transferred to the automatic agent battery and the call router 114 may be configured to route inbound calls to connected callers to automatic service agents 116A, 116B which are configured to prompt the caller for further information which may be used to process the call. For example, the automatic service agents may establish the callers preferred language of communication and then to use conversational questions and answers to ask prompting questions to obtain information pertinent to the service required, to assign a prioritization index to the call and to categorize the call, for example as an emergency call, a non-emergency call, a harassment call, a nuisance call, a service request call, an information request call, an extension call, a routing call, a common call, a repeat call and the like as well as combinations thereof. Where appropriate, the call screener 102 may use the call identifiers to apply a priority value to the associated inbound call before it is answered.

The call monitor 122 is operable to monitor all communication with the caller and to determine what course of action is required and where appropriate to connect the caller to a human service agent 116C for further assistance.

By way of example, the required course of action may be a banking process such as effecting a bank transfer, a currency transfer, a payment collection, a loan repayment or the like. In still other examples technical support may be provided to the caller perhaps via a human service agent or by remotely connecting to the caller's device. In particular examples the required action may be to dispatch an emergency response unit to the caller as described below.

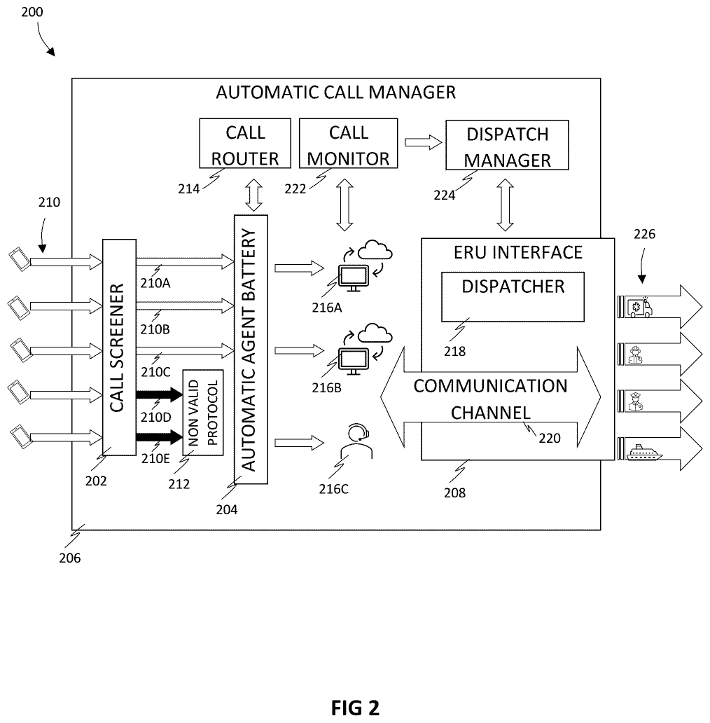

Reference is now made to the schematic diagram of FIG. 2 which represents selected elements of an automatic emergency call management system 200. The system includes an inbound call screener 202, an automatic agent battery 204, a management server 206 and an emergency rescue unit (ERU) interface 208.

Multiple inbound emergency calls 210 arrive at a public safety answering point (PASP) from multiple callers. The automatic call manager 206 is operable to obtain from the inbound calls 210 any available characteristic call identifiers such as phone numbers and caller locations. The characteristic call identifiers may be used to apply a priority value to the associated inbound call before it is answered.

Accordingly, the inbound call screener 202 is configured and operable to receive the inbound call identifiers and to identify invalid calls 210D, 210E. Some invalid calls such as prank calls or cyberterrorist attacks which aim to disrupt emergency services may be identifiable from the call identifiers. When an invalid call is identified, a non valid protocol 212 is initiated. For example, multiple repeated calls from the same telephone number may be deprioritized or rejected and a suspected viral attack may be flagged. It is noted that, where appropriate, the invalid call protocol 212 may notify authorities automatically notified of the offence in real time.

Furthermore, multiple valid inbound calls 210A, 210B may all relate to a common emergency. This may be identifiable from a batch of calls from a common location at a common time, for example. In such an event, repeat inbound calls from the same location may be processed less urgently than other incoming calls.

The management server may include an automatic call distributer configured and operable to apply a priority value to each inbound call, and a call router 214 configured to route inbound calls to appropriate customer service agents 216A, 216B, 216C.

Typically, the first answer point to which an inbound call is directed is to an automatic agent 204 which is operable to function as a customer service agent answering an emergency call. The automatic agent 204 may be operable to interact verbally with the caller using natural language prompts to obtain useful information from the caller.

It is a particular feature of automatic agents 204 that they may not be limited by language and may be operable to detect the preferred language of the caller and to use this language for any further communication without any loss of time.

The automatic customer service agent 204 may therefore be configured to answer inbound calls, to communicate with the caller, to prompt the caller for key information. This key information may be used by the automatic management system to determine if further action is required and what that action should be.

It is noted that the automatic management system may include a call monitor 222 operable to monitor all communication with the caller and to determine if an emergency response unit 226 is required. When sufficient data has been obtained to indicate that an ERU is required, the automatic call management system 206 may instruct the dispatch manager 224 to dispatch the appropriate ERU 226, such as a firefighting unit, an ambulance, a law enforcement unit, a coastguard or the like. Notably the dispatch manager 224 operates in parallel with the agent 216A, 216B, 216C allowing the ERU 226 to be dispatched even before the call is completed.

Where required, the automatic customer service agent 204 may determine that a human service agent may be required, for example where medical advice or other specialist advice is required. Accordingly, the call router 214 may connect the caller to a live human agent 216C as needed.

The emergency rescue unit (ERU) interface 208 provides a dispatcher 218 configured and operable to dispatch ERUs 226 and to communicate with the dispatch units key information such as location and nature of the emergency. The ERU interface 208 further provides an ongoing communication channel 220 between the call management system 206 and the dispatched units 226.

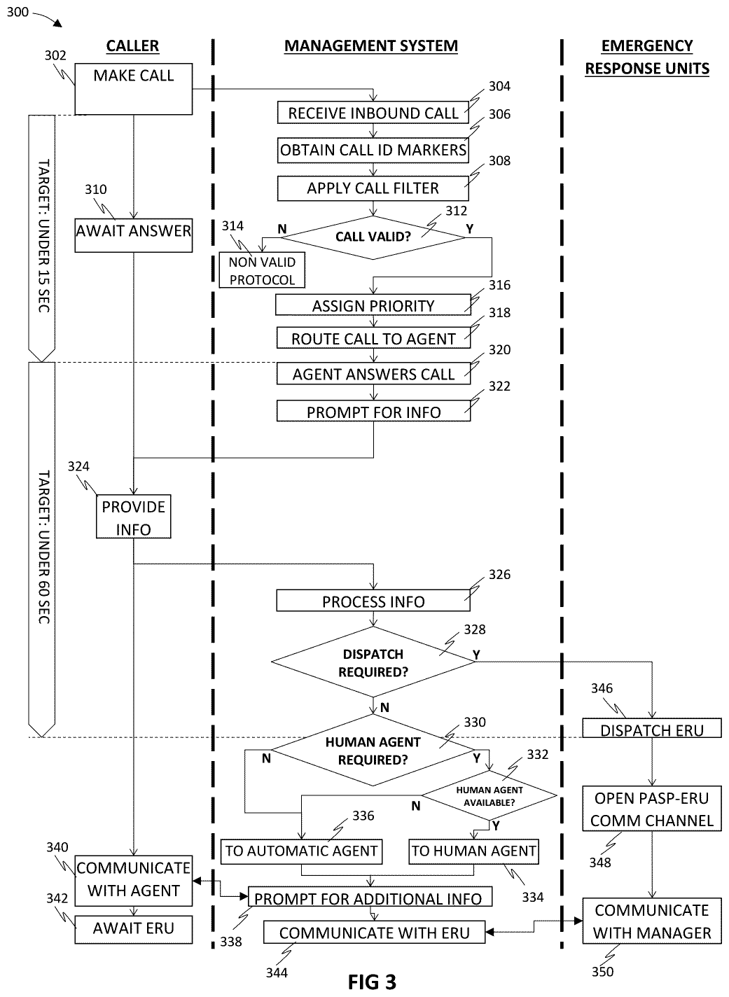

Referring now to the flowchart of FIG. 3, which illustrates selected actions of a method 300 for processing an emergency call using the automatic emergency call management system 200.

A caller makes an emergency call 302 such as a 9-1-1 call in The United States, a 1-2-2 call in Europe or the like. The caller then awaits the call to be answered 310. It is noted that the target waiting time for the first phase of the call processing is under 15 seconds until the call is answered.

During this waiting time the emergency call is typically routed to a PASP along with characteristic identification markers 306 such as telephone number, location and the like.

The emergency call management system receives the inbound call 304 and obtains the information from the identification markers 306. According to these markers a call filter 308 is applied to determine if the call is a valid call 312 which needs to be answered or not.

If the inbound call is not valid then the non-valid protocol 314 is initiated and the call may be deprioritized or even rejected. Furthermore, where appropriate, further action may be taken such as alerting authorities to prevent further invalid calls.

If the inbound call is valid then the call may be assigned a priority value 316 based upon the identification markers and the call is routed to an agent 318. Typically the first agent is selected from a battery of automatic customer service agents. The customer service agent answers the emergency call 320.

As noted above, the target waiting time during the first phase of the call processing is under 15 seconds, however using this system it may be possible to achieve even faster response times than this.

The second phase of the call processing starts once the agent answers the call and the target time for the second phase of the call processing from the time the call is answered is under 60 seconds until an Emergency rescue unit is dispatched if deemed necessary.

The automatic agent typically answers verbally to the caller and prompts the caller for key information 322 preferably using natural language. Optionally, the agent may identify the caller's preferred language and adjust the language used to suit the caller.

The caller provides additional information 324 as required which is processed 326 by the management system to categorize the call to determine whether a dispatch unit is required 328, what service is required and to what destination that dispatch unit should be sent.

If the call is determined to be an emergency requiring a dispatch unit, the management may immediately dispatch the ERU 346 without further delay. A PASP-ERU communication channel is established 348 to allow continued communication of information between the dispatched unit and the incident managers 350 throughout the process.

As noted above, the target time for the second phase of the call processing is under 60 seconds until a unit is dispatched. Again it is noted that using this system it may be possible to achieve even faster response times than this.

In parallel communication with the caller continues and the automatic agent may determine if a human customer service agent is required 330. If a human agent is available 332 then the call may be routed to a human customer service agent 334, alternatively, if no human agent is available, the automatic agent may continue to manage the call 336.

Additional information may be obtained through further prompting 338 by the automatic or human agent. When relevant this information may be communicated with the ERU 344 via the established communication channel.

Accordingly the caller may continue to communicate with the agent 340 for as long as necessary as they await the ERU 342.

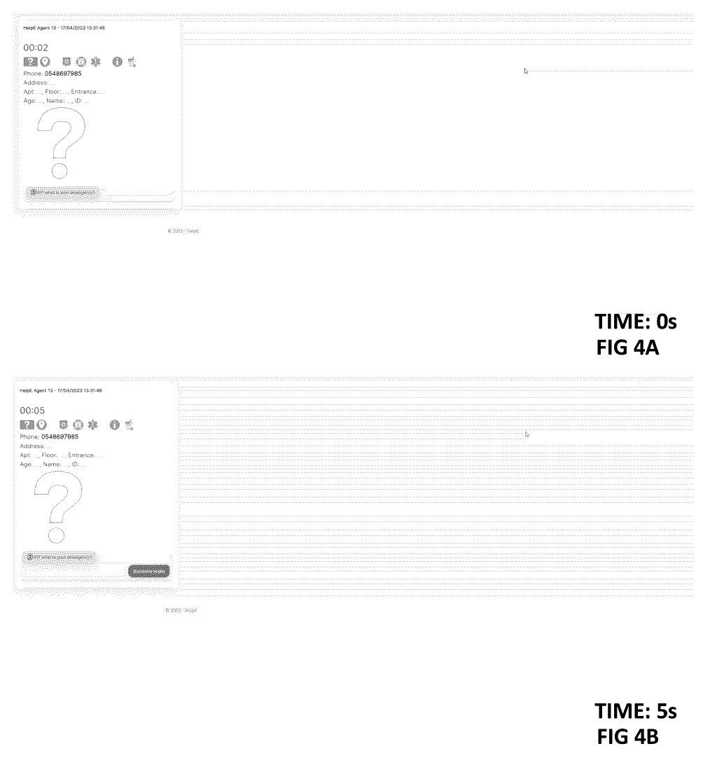

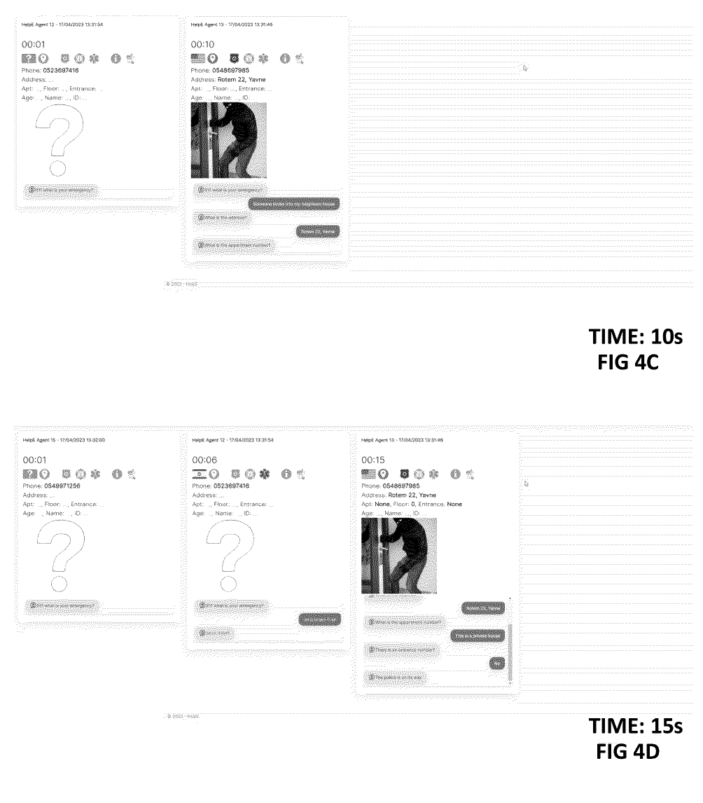

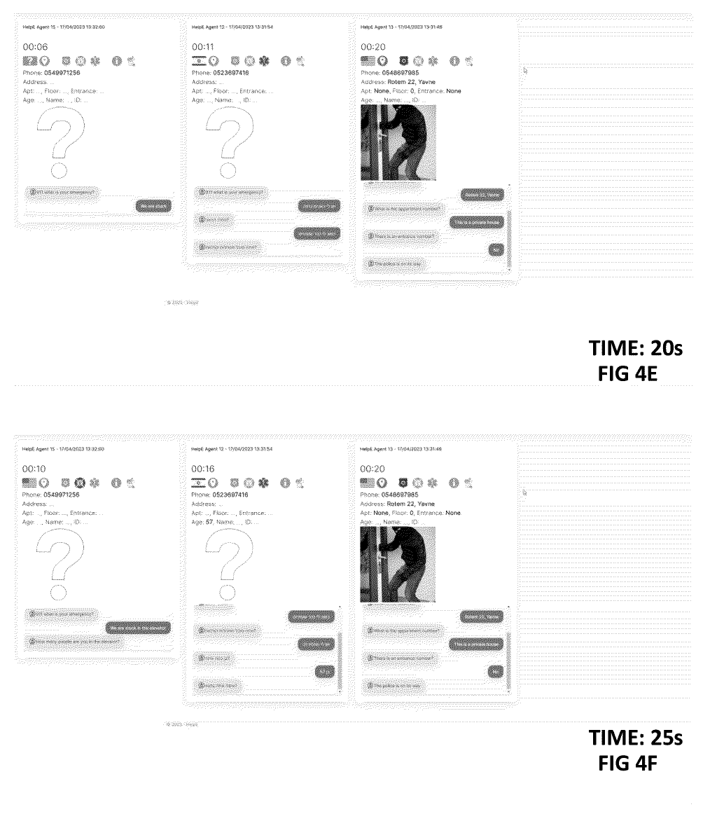

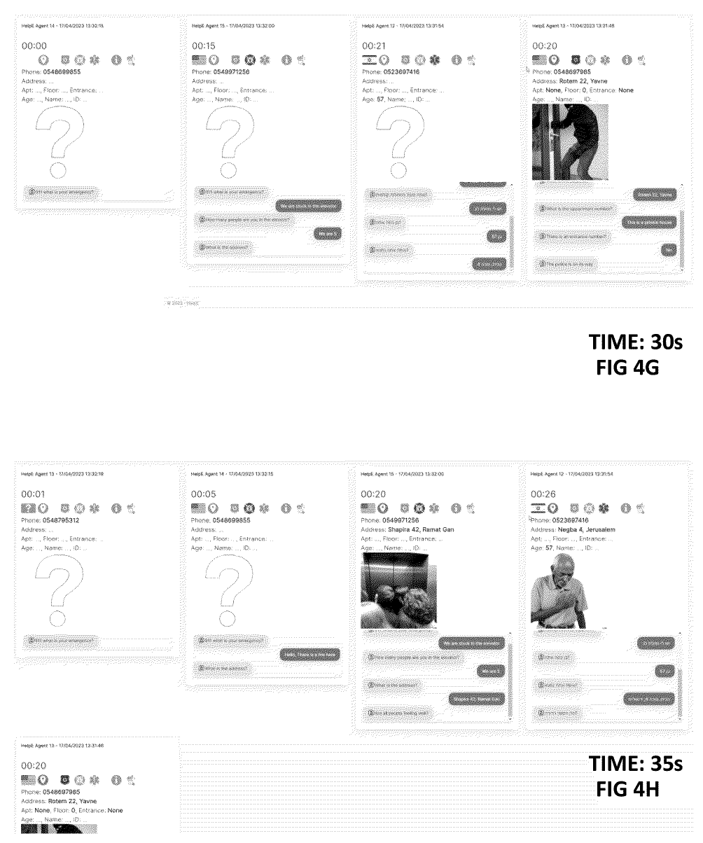

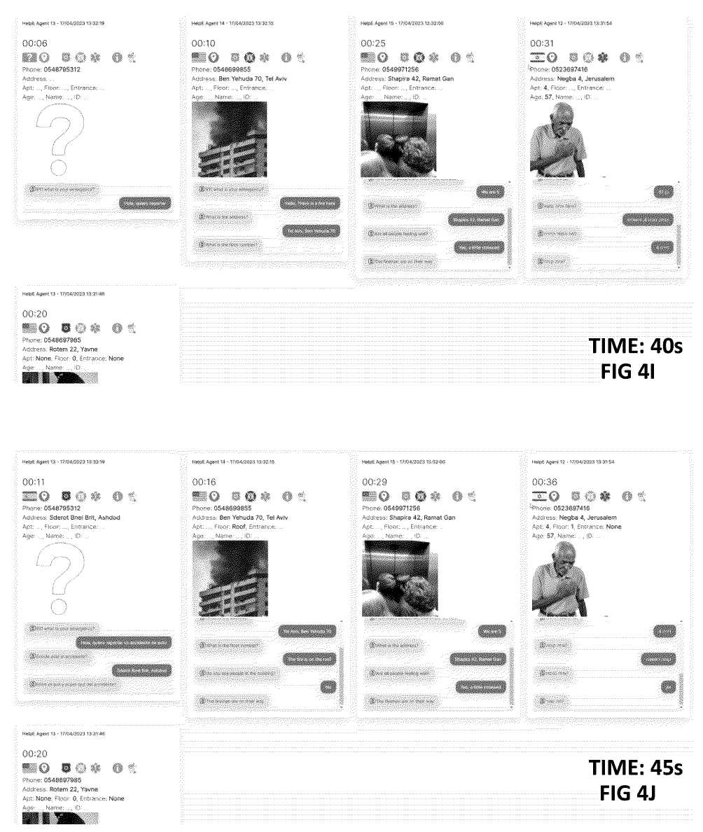

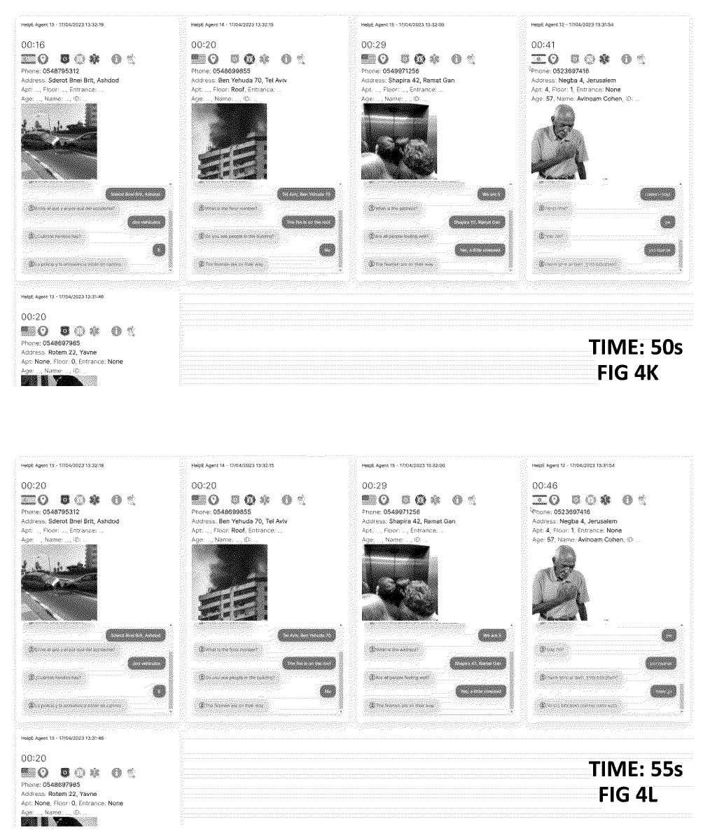

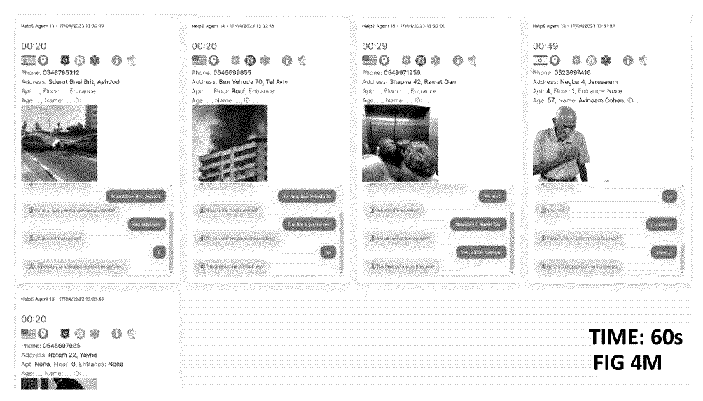

Referring now to the illustrative screen shots of FIGS. 4A-N, multiple emergency calls being handled by multiple automatic agents in parallel during a typical minute of operation of the emergency system.

In the example of FIGS. 4A-M screenshots are presented illustrating 5 second intervals during a typical minute in which multiple emergency calls are handled by multiple automatic agents in parallel.

As shown in FIG. 4A, The minute starts with a first automatic agent, Agent 13 receiving a call from a first caller—the phone number of caller is known but the rest of the key information is unpopulated. The agent prompts with the opening question “what is your emergency.”

As shown in FIG. 4B, after 5 seconds, the caller starts to provide information “someone broke into my neighbors house”

As shown in FIG. 4C, at 10 seconds the first caller has already provided sufficient information to populate the key information: nature of emergency (requiring law enforcement) as well as the address. At this point an ERU may already be dispatched, while further information is gathered.

In parallel a second automatic agent, Agent 12 receives a call from a second caller—the phone number of second caller is known but the rest of the key information is unpopulated. The agent again prompts with the opening question “what is your emergency.”

As shown in FIG. 4D, at 15 seconds the first caller has already been informed that police are on their way. Meanwhile the second caller has responded in a foreign language identified to be Hebrew and the system has proceeded with Hebrew language prompts to establish that the nature of the emergency is medical.

In parallel a third automatic agent, Agent 15 receives a call from a third caller.

As shown in FIG. 4E, at 20 seconds further information has been gathered from the second and third callers and the agents prompt for more.

As shown in FIG. 4F, by 25 seconds the first agent, Agent 13 has completed the processing of the first caller emergency while still further information is gathered from the second caller and the third caller has established that the emergency will require fire rescue services.

As shown in FIG. 4G, at 30 seconds, in parallel, a fourth agent, Agent 14 receives a call from a fourth caller.

As shown in FIG. 4H, by 35 seconds the location of the second and third callers have been established and suitable ERU dispatch units sent. Meanwhile the fourth agent, Agent 14 has established that firefighters are required.

Note that a fifth call is received and is answered by the first agent, Agent 13, which has been freed up by completing processing the first call.

As shown in FIG. 4I, by 40 seconds the location of the fourth callers has been established and suitable ERU dispatch units sent, while the agents continue to communicate with the callers.

As shown in FIG. 4J, at 45s the fifth callers foreign language has been identified and Agent 13 has populated the location information and established that law enforcement units are required at a traffic accident.

As shown in FIG. 4K, by 50 seconds the third and fourth caller emergencies have been processed and the agents freed up to receive new calls.

Meanwhile the fifth caller has further communicated that in addition to the police, ambulance services are also required at the traffic accident. The units are dispatched accordingly.

As shown in FIG. 4L, by 50 seconds the fifth caller emergencies has also been processed and Agent 13 is again freed up to receive new calls. Note that all this time, the second agent continues to communicate with the second caller.

As shown in FIG. 4M, by 60 seconds all five calls have been fully processed.

Technical and scientific terms used herein should have the same meaning as commonly understood by one of ordinary skill in the art to which the invention pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

As used herein the term “about” refers to at least ±10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment of the invention described as “exemplary” is not necessarily to be construed as preferred or advantageous over other embodiments of the invention or to exclude the incorporation of features from other embodiments of the invention.

The word “optionally” is used herein to mean “is provided in some embodiments of the invention and not provided in other embodiments of the invention”. Any particular embodiment of the invention may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the invention, which are, for clarity, described in the context of separate embodiments of the invention, may also be provided in combination in a single embodiment of the invention. Conversely, various features of the invention, which are, for brevity, described in the context of a single embodiment of the invention, may also be provided separately or in any suitable sub-combination or as suitable in any other described embodiment of the invention. Certain features described in the context of various embodiments are not to be considered essential features of those embodiments of the invention unless the embodiment of the invention is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the invention.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the invention. To the extent that section headings are used, they should not be construed as necessarily limiting.

The scope of the invention includes both combinations and sub combinations of the various features described hereinabove as well as variations and modifications thereof, which would occur to persons skilled in the art upon reading the foregoing description.

What is claimed is:

1. A method for managing service calls comprising:
receiving at least one incoming telephone call;
screening the at least one incoming call;
if the incoming call is from a valid caller then executing a valid call protocol;
wherein the valid call protocol comprises
connecting the valid caller to a service agent,
prompting the valid caller for information pertaining to the service required,
receiving the information pertaining to the service required,
processing information pertaining to the service required,
determining a required action, and
executing the required action.

2. The method of claim 1 wherein the step of screening comprises assigning a prioritization index to a valid caller.

3. The method of claim 1 wherein the step of screening comprises obtaining call identification markers.

4. The method of claim 3 wherein the call identification markers comprise caller phone numbers.

5. The method of claim 3 wherein the call identification markers comprise caller locations.

6. The method of claim 3 wherein the call identification markers comprise an advance mobile location.

7. The method of claim 1 wherein the step of screening comprises executing a non-valid call protocol if the incoming call is from a non-valid caller.

8. The method of claim 7 wherein the non-valid call protocol comprises rejecting the non-valid call.

9. The method of claim 7 wherein the non-valid call protocol comprises reporting the non-valid caller to authorities.

10. The method of claim 7 wherein the non-valid call protocol comprises alerting law enforcement.

11. The method of claim 1 wherein the step of executing the required action comprises providing service information to the caller.

12. The method of claim 1 wherein the step of executing the required action comprises establishing a parallel remote connection to a caller device.

13. The method of claim 1 wherein the set of executing the required action comprises dispatching an emergency response unit.

14. The method of claim 1 wherein the set of executing the required action comprises determining if an emergency dispatch is required.

15. The method of claim 1 wherein the step of executing the required action comprises connecting the caller to a human service agent.

16. The method of claim 1 further comprising establishing a preferred language for communicating and asking prompting questions in the preferred language for communicating with the caller.

17. The method of claim 1 further comprising categorizing the incoming call according to the information prompted from the caller by assigning a category selected from: emergency call, non-emergency call, harassment call, nuisance call, service request call, information call, extension call, routing call, common call, repeat call and combinations thereof.

18. A method for providing automatic emergency call management the method comprising:
receiving an incoming call from a caller;
obtaining incoming call identification markers;
applying a call filter;
assigning a prioritization value to the incoming call;
routing call according to prioritization value;
connecting automatic service agent to caller;
automatic agent prompting caller for information;
categorizing call according to the information prompted from the caller;
establishing that a dispatch is required;
checking if an emergency response unit has already been dispatched; and
if no emergency response unit has already been dispatched then dispatching unit to emergency.

19. A system for providing automatic service-call management, the system comprising:
an inbound call screener configured and operable to receive inbound call identifiers, to identify nuisance calls, and to block identified nuisance calls;
an automatic call distributer configured and operable to prioritize inbound calls;
a call router configured to connect a caller to at least one automatic customer service agent;
at least one automatic customer service agent configured to prompt the caller for key information and to store the key information in a memory; and
a call processor configured to determine a required course of action for the incoming call.

20. The system of claim 1 wherein the required course of action is selected from dispatching emergency units, connecting a human service agent, reassuring a caller and combinations thereof, and communicating with emergency dispatch units.
